(19) United States
(12) Patent Application Publication
(10) Pub. No.: US 2002/0168895 A1
(43) Pub. Date: Nov. 14, 2002

(54) Holder-attached connector

(75) Inventor: Kenji Suzuki, Shizuoka (JP)

Correspondence Address: SUGHRUE MION, PLLC, 2100 PENNSYLVANIA AVENUE, N.W., WASHINGTON, DC, 20037, US

(73) Assignee: YAZAKI CORPORATION

(21) Appl. No.: 10/141,874

(22) Filed: May 10, 2002

(30) Foreign Application Priority Data
May 11, 2001 (JP) P2001-142132

(51) Int. Cl. H01R 13/40; H01R 13/514

(52) U.S. Cl. 439/595; 439/752

(57) ABSTRACT

Elastic arms extending in a holder inserting direction are formed on a holder. A provisionally-retaining portion and a completely-retaining portion for engagement with a connector housing are provided on the elastic arms, and arm insertion portions for respectively embracing the elastic arms are provided at the connector housing. The arm insertion portion has opposed guide surfaces for sliding contact with opposite side faces of the elastic arm mutually spaced in a thickness direction of the elastic arm. The provisionally- and completely-retaining portions are retaining pawl and retaining projection, respectively. An engagement pawl for the retaining pawl and an engagement projection for the retaining projection are provided at the arm insertion portion. The elastic arm includes a pair of beam portions, and the provisionally-retaining portion is provided at one of the beam portions while the completely-retaining portion is provided at the other beam portion.

The present application is based on Japanese Patent Application No. 2001-142132, which is incorporated herein by reference.

### BACKGROUND OF THE INVENTION

1. Field of the Invention

This invention relates to a holder-attached connector provided with a holder for supporting male terminals to accurately position these terminals.

2. Related Art

Types of connectors for electrically connecting wires, installed on a vehicle or the like, includes a so-called male connector and a so-called female connector, and each of these connectors comprises a connector housing, and terminals received respectively in terminal receiving chambers formed in the connector housing. The male terminals, each having a tab-like electrical contact portion, are received respectively in the terminal receiving chambers in the connector housing.

The tab-like electrical contact portion is thin and elongate, and therefore is liable to be bent, and this electrical contact portion has a problem that it is liable to be out of alignment with a female terminal received in a mating male connector. In order to solve this problem, there has been used a female connector provided with a holder. The holder is separate from a connector housing, and is slidingly inserted into an opening in the housing.

One example of such holder-attached connectors is disclosed in JP-A-4-209479.

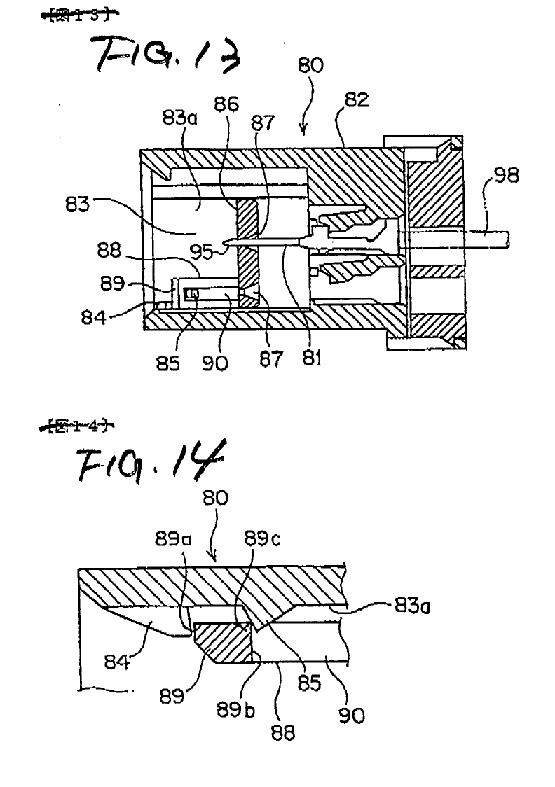

As shown in FIGS. 12 and 13, this female connector 80 receives male terminals 81 (each connected to a wire 98) therein, and has a holder 86 received in a fitting space 83 for receiving a mating connector (male connector) 91. Terminal passage holes 87, corresponding in number to the male terminals 81,. are formed through the holder 86, and arms 88 are formed on and extend from longitudinal opposite ends of the holder 86, respectively.

Before the male connector 91 is fitted into the female connector 80, the holder 86 is disposed in a provisionally-retained position, and an end portion 89 of each arm 88 is held between a first projection 84 and a second projection 85 which are formed on a corresponding inner surface 83a of the fitting space 83 (FIG. 14). The end portion 89 has an outer surface 89a (directed toward the opening) and an inner surface 89b, and the outer surface 89a forms an engagement portion for engagement with the first projection 84 whereas a corner portion 89c of the inner surface 89b forms an engagement portion for engagement with the second projection 85.

Therefore, the holder 86 will not be withdrawn forwardly from the female connector 80, and also this holder will not be moved deeper unless the male connector 91 is inserted. Therefore, the holder 86 is prevented from being accidentally moved during the transport of the female connector 80.

Third projections 92 (see FIG. 12) are formed respectively on opposite side surfaces of the male connector 91, and each of these third projections can force the end portion 89 of the corresponding arm 88 of the holder 86 outwardly. The third projection 92 has a slanting surface 92a of a predetermined angle, and when the male connector 91 is inserted into the fitting space 83 in the female connector 80, the holder 86 is pushed toward the deep side.

With this construction, before the male connector 91 and the female connector 80 are fitted together, the holder 86 is provisionally retained by the second projections 85, and is prevented from withdrawal by the first projections 84 abutted respectively against the outer surfaces 89a of the arms. When the male connector 91 is inserted into the female connector 80, the arms 88 are elastically deformed outwardly by the third projections 92, respectively, and therefore the holder 86, while kept in the provisionally-retained position, allows the insertion of the male connector 91. When the male connector 91 is further inserted, a front surface of the male connector 91 presses a front surface 86a of the holder 86, so that each arm 88 slides past the second projection 85, and the holder 86 is completely retained.

However, the above conventional holder-attached connector has the following problems to be solved.

Firstly, the arms 88 of the holder 86 extend toward the opening of a connector housing 62, that is, toward the male connector 91, and therefore there is encountered a problem that when the male connector 91 is inserted, the front surface of the male connector 91 can interfere with the distal ends of the arms 88 to bend these arms.

Secondly, during the transport of the female connector 80, having the male terminals 81 received in the connector housing 82, the holder 86 can be accidentally moved from the provisionally-retained position to the deeper, completely-retained position. Namely, if a foreign matter, such as a pin, intrudes into the fitting space 83 in the female connector 80, this foreign matter presses the front surface 86a of the holder 86 toward the deep side, and each arm 88 can be brought out of engagement with the corresponding second projection 85, so that the holder 86 is moved from the provisionally-retained position toward the completely-retained position. This depends on the retaining construction of the holder 86, and if the arms 88 are inclined or bent inwardly (laterally) in the resin-molding, so that the amount of retaining engagement of each arm 88 with the second projection 85 is small (or zero), the arm 88 is inwardly displaced out of position. When the holder 86 is moved deeper from the provisionally-retained position, the thin, elongate tab-like electrical contact portions 95 become free, and can be easily deformed upon interference with a foreign matter or the like. Even if such interference with the foreign matter or the like does not occur, there is a fear that the male terminals 81 are deflected, and fail to be accurately positioned since they are not supported and guided by the holder 86.

The holder 86 has no guide rib, and the connector housing 82 has not guide groove for guiding such a guide rib, and therefore there is a fear that when fitting the holder 86 into the fitting space 83 in the connector housing 82, the holder 86 moves irregularly or jolts, and can not be smoothly inserted into the fitting space 83. When the holder 86 is inserted in an inclined manner, the holder 86 is brought into contact with the tab-like electrical contact portions 95 to deform the same, which leads to a possibility that the electrical contact thereof with the mating terminals (female terminals) is not ensured.

### SUMMARY OF THE INVENTION

In view of the foregoing, it is an object of this invention to provide a holder-attached connector in which a holder is prevented from being moved forward and rearward out of a provisionally-retained position within a fitting space so that male terminals, projecting into the fitting space in a connector housing, can be protected and positioned, and besides the holder can be inserted into the fitting space in the connector housing without jolting.

(1) The above object has been achieved by a holder-attached connector, which comprises a connector housing, including a fitting hood having a fitting space, male terminals, inserted respectively in terminal receiving chambers communinating with the fitting space, and a holder which has terminal passage holes for the male terminals, and is slidingly inserted in the fitting space; characterized in that an elastic arm is formed on the holder, and extends in a direction of insertion of the holder; and a provisionally-retaining portion and a completely-retaining portion for engagement with the connector housing are provided at the elastic arm; and an arm insertion portion for embracing the elastic arm is provided at the connector housing.

In this construction, when the holder is inserted into the fitting space in the connector housing, the elastic arm, extending in the direction of insertion of the holder, enters the arm insertion portion, and the provisionally-retaining portion and the completely-retaining portion of the elastic arm are retained against movement in the forward and rearward direction by the arm insertion portion, so that the holder is held in a provisionally-retained condition. Then, when a male connector is inserted into the fitting space, the holder is pushed toward the deep side, and at the same time the elastic arm further advances deeper, so that the holder is held in a completely-retained condition. In the provisionally-retained condition and in the completely-retained condition, the elastic arm is embraced by the inner surface of the arm insertion portion on four sides, and therefore the retained condition is prevented from being canceled.

(2) In the invention, the elastic arm can be elastically deformed in the direction of the width thereof, and the arm insertion portion has a pair of opposed guide surfaces spaced from each other in a direction perpendicular to the direction of elastic deformation of the elastic arm.

In this construction, the arm insertion portion has the pair of opposed guide surfaces, and therefore the elastic arm is inserted into the arm insertion portion while slidingly held between (and hence guided by) the pair of guide surfaces, so that the inward (lateral) inclining of the elastic arm is prevented.

(3) In the invention, the provisionally-retaining portion is a retaining pawl, and the completely-retaining portion is a retaining projection, and an engagement pawl for the retaining pawl and an engagement projection for the retaining projection are provided at the arm insertion portion.

In this construction, the elastic arm is inserted into the arm insertion portion, and when the retaining pawl slides past the engagement pawl, the provisionally-retained condition is achieved. The retaining pawl is retainingly engaged with the engagement pawl, thereby preventing the holder from being withdrawn forwardly from an opening of the connector housing. In this condition, the retaining projection is disposed at the inner side of the engagement projection, thereby preventing the holder from sliding from the provisionally-retained position toward the deep side. A predetermined pushing force is required for sliding the holder, and the sliding of the holder is effected when the mating male connector is fitted into the connector of the invention. Namely, the male connector is fitted into the fitting space to push the holder toward the deep side, so that a front surface of the male connector is brought into contact with the front surface of the holder, and when the holder is further pushed with a larger force, the retaining projection slides past the engagement projection, so that the completely-retained condition is achieved.

(4) In the invention, the elastic arm includes a pair of beam portions, extending in the direction of insertion of the holder, and an end portion interconnecting the pair of beam portions, and the provisionally-retaining portion is provided at one of the pair of beam portions while the completely-retaining portion is provided at the other beam portion,

In this construction, the elastic arm of a generally rectangular frame-shape is formed by the pair of beam portions and the end portion interconnecting the pair of beam portions, and the provisionally-retaining portion and the completely-retaining portion are formed respectively on an upper surface of the one beam portion and a lower surface of the other beam portion, respectively, and with this construction the two beam portions can be elastically deformed toward each other, and therefore the elastic arm can be smoothly inserted into the arm insertion portion.

(5) In the invention, the arm insertion portions are provided respectively at opposite side walls of the connector housing disposed adjacent to the fitting space.

In this construction, the arm insertion portions are provided respectively at the opposite side portions of the connector housing, and therefore the elastic arms, provided respectively at the opposite sides of the holder, can be inserted respectively into the arm insertion portions, and the retaining of the holder can be effected in a well-balanced manner in the right-left direction.

(6) In the invention, the arm insertion portion is provided at a central portion of a wall portion of the connector housing interconnecting the opposite side walls of the connector housing.

In this construction, the arm insertion portion is provided at the central portion of the wall portion, and therefore the dimension of the connector housing in the direction of the width thereof is prevented from increasing.

(7) In the invention, the retaining pawl, formed on one of the elastic arms for insertion into the corresponding arm insertion portion, and the retaining pawl, formed on the other elastic arm for insertion into the other arm insertion portion, are directed reversely to each other.

In this construction, the retaining pawls, formed respectively on the elastic arms, are directed reversely to each other, and therefore reaction forces, acting respectively on the two elastic arms, can be directed reversely to each other, so that the holder can be retained firmly.

(8) In the invention, each of the retaining pawl and the engagement pawl has a vertical retaining surface disposed perpendicular to the direction of insertion of the holder, and each of the retaining projection and the engagement projection has slidable, sliding slanting surfaces formed respectively at front and rear sides thereof.

In this construction, the retaining pawl and the engagement pawl have the vertical retaining surfaces, respectively, and the two vertical surfaces are pressed hard against each other to thereby provisionally retain the holder, and therefore the holder is prevented from being withdrawn forwardly from the opening of the connector housing. Each of the retaining projection and the engagement projection has slidable, sliding slanting surfaces, and the retaining projection and the engagement projection are slidably abutted against each other at their sliding slanting surfaces, and therefore the holder can be slid in the opposite directions between the completely-retained position and the provisionally-retained position.

(9) In the invention, the retaining pawl and the engagement pawl jointly form a first retaining device, and the retaining projection and the engagement projection jointly form a second retaining device, and the holder is held in the provisionally-retained position by the first retaining device and the second retaining device.

In this construction, the holder is held in the provisionally-retained position by the first and second retaining devices, and therefore a tab-like electrical contact portion of each male terminal is supported by the holder, disposed in the provisionally-retained position, and is prevented from interfering with an external object, and therefore is prevented from being broken or bent. Namely, when the holder is disposed in a half-inserted position, the tab-like electrical contact portions are supported at their generally middle portions by the holder, and therefore the length of projecting of the free end portion of each electrical contact portion is reduced, and the breakage and bending thereof are prevented, and besides the positioning of the male terminals is effected accurately.

(10) In the invention, a guide rib for being guided by a guide groove, formed in the fitting hood, is formed on the holder.

In this construction, the guide rib is formed on the holder, and therefore the guide rib is guided by the guide groove, so that the holder is accurately positioned in the direction of the width thereof, and besides the elastic arm is positively inserted into the arm insertion portion.

(11) In the invention, a reinforcing rib for insertion into a rib receiving portion, formed in a front wall of a housing body disposed adjacent to the fitting hood, is formed on the holder.

In this construction, the reinforcing rib, is formed on the holder, and this reinforcing rib is engaged in the rib receiving portion, thereby preventing the holder from being inclined forwardly and rearwardly, and by doing so, the burden on the elastic arm is reduced, and as a result the elastic arm is reinforced. And besides, the positioning of the holder in the direction of the height is accurately effected, so that each male terminal can be guided and supported on a straight line.

### BRIEF DESCRIPTION OF THE PREFERRED EMBODIMENTS

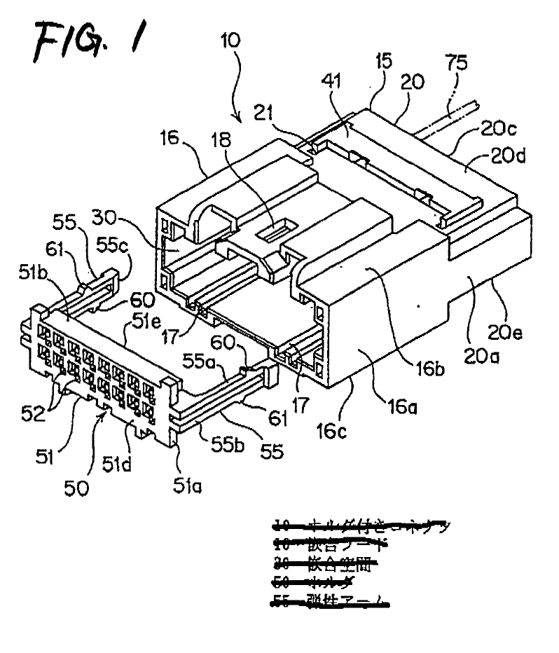

FIG. 1 is an exploded, perspective view of a first embodiment of a holder-attached connector of the present invention;

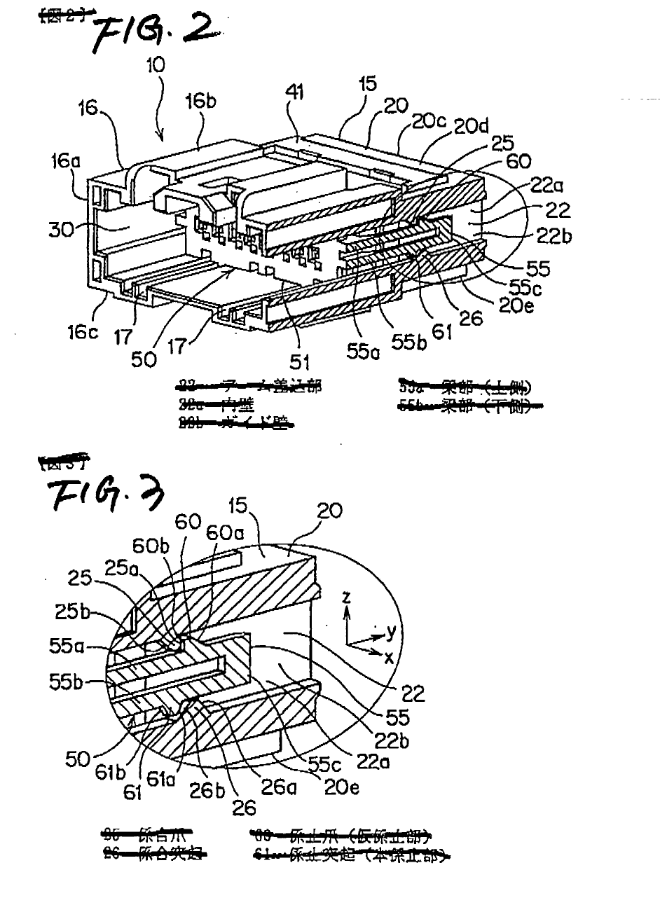

FIG. 2 is a perspective view showing an internal structure of the holder-attached connector of FIG. 1 having a holder attached to a connector housing;

FIG. 3 is an enlarged view showing a condition in which the holder of the holder-attached connector of FIG. 2 is retained;

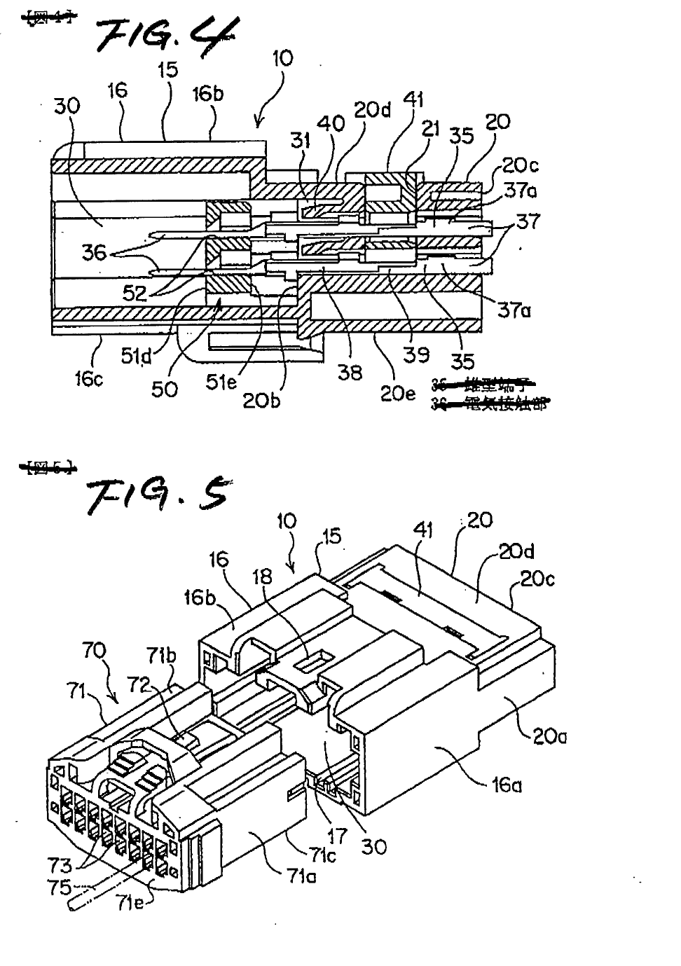

FIG. 4 is a cross-sectional view of the holder-attached connector of FIG. 1, having male terminals inserted therein;

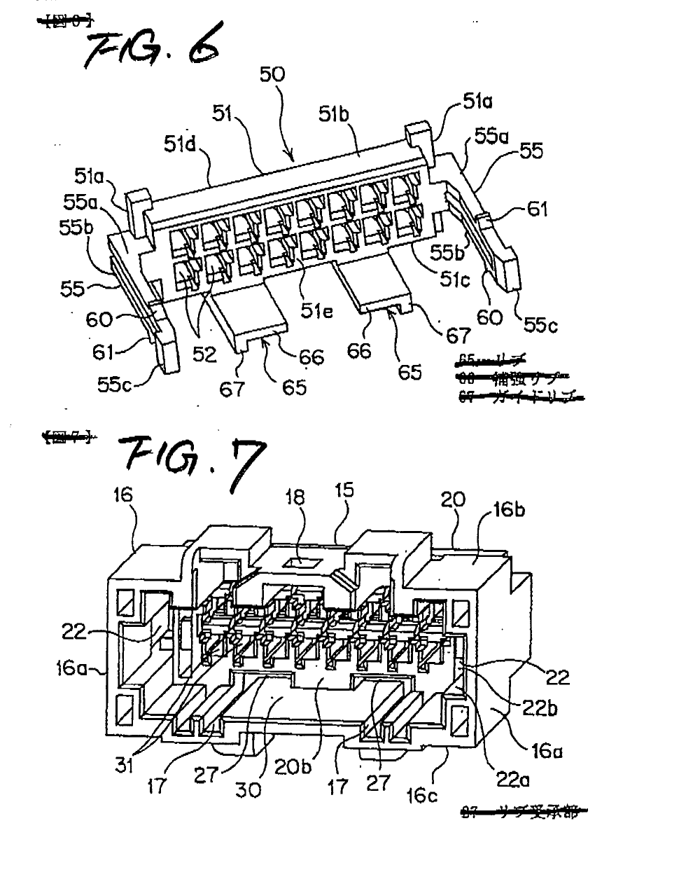

FIG. 5 is a perspective view showing a male connector for fitting in the holder-attached connector of FIG. 1;

FIG. 6 is a perspective view showing ribs formed on and projecting from the holder;

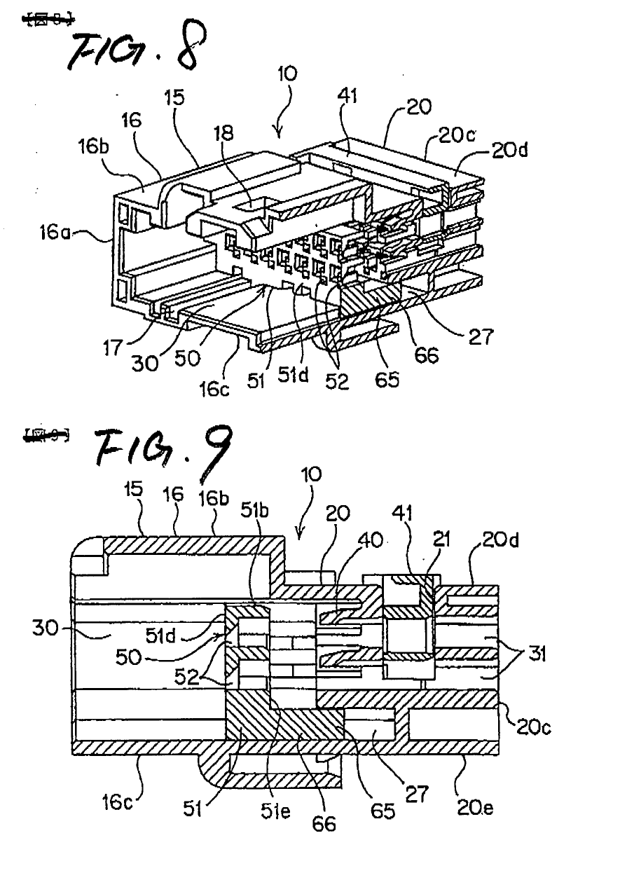

FIG. 7 is a perspective view showing rib receiving portions formed in the holder-attached connector;

FIG. 8 is a view showing a condition in which the ribs, shown in FIG. 6, are inserted in the rib receiving portions, respectively;

FIG. 9 is a view showing a condition in which the holder is positioned in a direction of the height by the ribs;

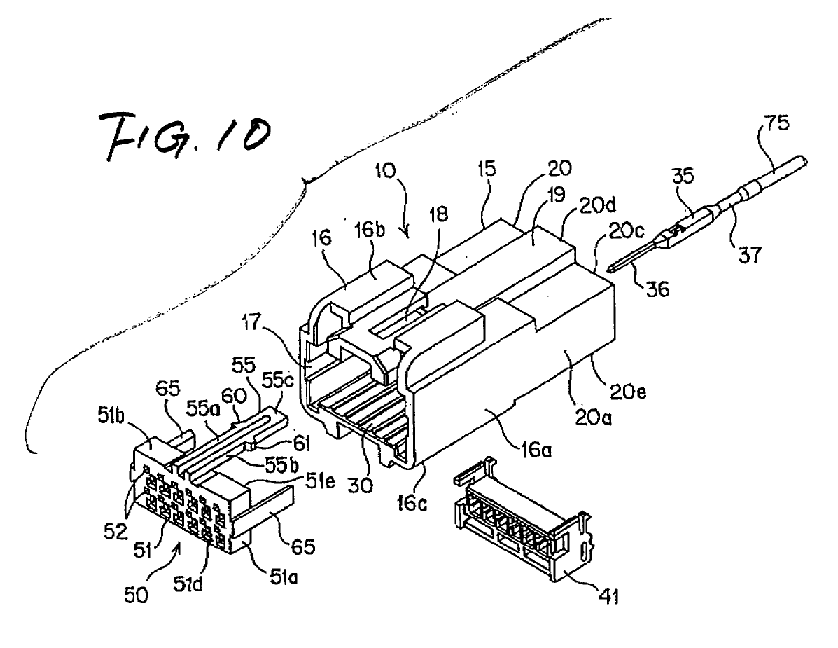

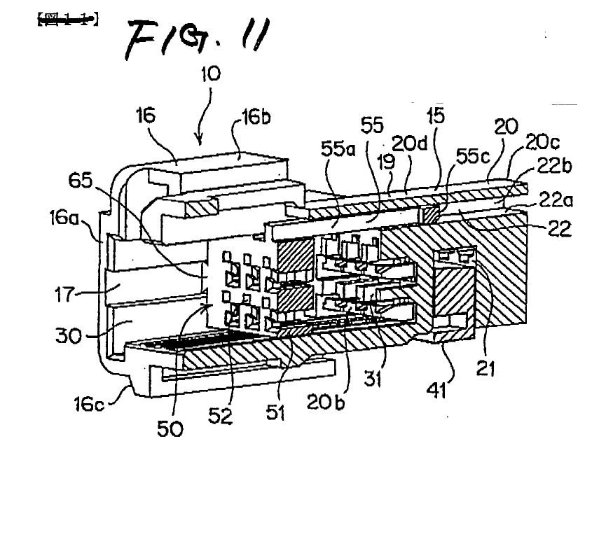

FIG. 10 is an exploded, perspective view of a second embodiment of a holder-attached connector of the invention;

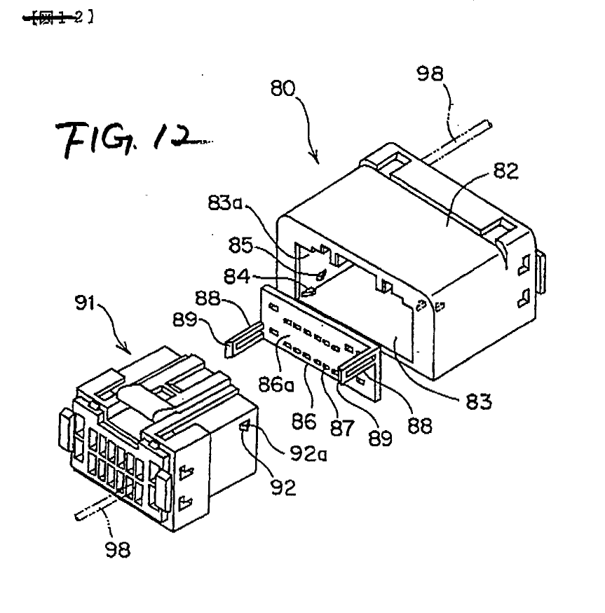

FIG. 11 is a perspective view showing an internal structure of the holder-attached connector of FIG. 10 having a holder attached to a connector housing;

FIG. 12 is an exploded, perspective view of one conventional holder-attached connector;

FIG. 13 is a cross-sectional view showing a condition in which a holder, shown in FIG. 12, is disposed in a provisionally-retained position within a fitting space of a connector housing; and

FIG. 14 is a view explanatory of a retaining device for retaining the holder of FIG. 12 relative to the connector housing.

### DETAILED DESCRIPTION OF THE PREFERRED EMBODIMENTS

A preferred embodiment of the present invention will now be described in detail with reference to the drawings.

FIGS. 1 to 9 show a first embodiment of a holder-attached connector of the invention.

As shown in FIGS. 1 and 2, the holder-attached connector (hereinafter often referred to as “connector”) 10 for fitting on a mating male connector 70 (see FIG. 5) comprises a connector housing 15, having a fitting hood 16 (serving as a front half portion thereof and having a fitting space 30 therein) formed integrally therewith, male terminals 35 (see FIG. 4), inserted respectively in terminal receiving chambers 31 communinating with the fitting space 30, and a holder 50 slidingly inserted in the fitting space 30.

The connector housing 15 is so constructed that the male connector housing 70 can be received and held in the fitting space 30 in the fitting hood 16, and this connector housing 15 is a so-called female connector housing 15. The connector housing 15 is broadly divided into the fitting hood 16 (front half portion) and a housing body 20 (rear half portion).

The terminal receiving chambers 31 (see FIGS. 4 and 7) for respectively receiving the male terminals 35 are formed in the housing body 20, and are arranged in two (upper and lower) rows in a matrix-like manner, each row of male terminals 35 being arranged at a predetermined pitch. The arrangement of the terminal receiving chambers 31 is not limited to the two (upper and lower) rows, but can be three, four or more rows. For description purposes, with respect to the front and rear sides, that side for fitting on the mating male connector 70 is defined as the front side while that side, into which the male terminals 35 are inserted, is defined as the rear side.

The fitting hood 16, defined by the front half portion, is molded into a, rectangular box-like shape, and that side thereof for fitting on the male connector 70 is open. The fitting hood 16 has a peripheral wall, defining the periphery thereof, and includes opposite side walls 16a and upper and lower walls 16b and 16c. A lock hole 18 for a lock projection 72 (see FIG. 5) of the male connector 70 is formed in the upper wall 16b. The lock device is not limited to the engaging device, formed by the projection 72 and the hole 18, but any other suitable engaging device, such as one comprising a pawl and a reception portion, can be used as the lock device. The engaging device, formed by the projection 72 and the hole 18, is relatively simple in construction, and therefore is effective for a compact connector or the like.

The fitting hood 16 is continuous at its rear end with the housing body 20. Here, in reference to the upper and lower sides, that side, on which the lock device is provided, is defined as the upper side, and that side, on which the lock device is not provided, is defined as the lower side with respect to the male connector 70. The upper and lower sides are thus defined merely for description purposes, and even if the upper and lower sides are reversed when the connector is used, there is no problem.

The housing body 20 has a peripheral wall 19, defining the periphery thereof, and includes opposite side walls 20a, front and rear walls 20b and 20c, and upper and lower walls 20d and 20e. This housing body is molded into a rectangular block-like shape. The plurality of terminal receiving chambers 31 (described above), as well as arm insertion portions 22 (more fully described later) for respectively receiving elastic arms 55 of the holder 50, are formed in the housing body 20 (see FIGS. 2 and 7).

The arm insertion portions 22 are formed respectively in the opposite side portions of the housing body 20 spaced from each other in the right-left direction (direction of the width thereof), and each arm insertion portion 22 has an inner surface 22a defining four sides of an inner peripheral surface thereof. The inner surface 22a of each arm insertion portion 22 serves also as guide surfaces 22b for the elastic arm 55. The guide surfaces 22b are opposed to each other in a direction x perpendicular to an upward-downward direction z (see FIG. 3) in which the elastic arm 55 can be elastically deformed, and the opposed guide surfaces 22b can be disposed in sliding contact respectively with the opposite sides (faces) of the elastic arm 55 spaced from each other in the direction of the thickness of this elastic arm.

An engagement pawl 25 and an engagement projection 26, which serve to hold the holder 50 in a provisionally-retained position, are formed on the inner surface 22a of each arm insertion portion 22, and are directed reversely to each other in the upward-downward direction, and are offset with respect to each other in a forward-rearward direction (direction y). The engagement pawl 25 and the engagement projection 26 are thus offset with respect to each other in the forward-rearward direction in order to prevent the holder 50 from moving forward and rearward out of the provisionally-retained position.

The retaining construction is not limited to the engagement pawl 25 and the engagement projection 26, but any other suitable retaining device for engagement with the corresponding elastic arm 55 can be used, and for example, grooves or recesses can be used. The engagement pawl 25 and the engagement projection 26 may be formed at one of the upper portion and the lower portion in such a manner that the two are juxtaposed to each other much like teeth of a saw.

The elastic arm 55 is restrained by the inner surface 22a of the arm insertion portion 22, and therefore is prevented from being laterally displaced out of position, and hence is prevented from disengagement. Here, the term “lateral displacement” device the inclining in the direction of disengagement of each elastic arm 55, that is, in the inward direction (direction x). Here, with respect to the right and left (direction x), opposite sides 51a of the holder 50 are disposed at the right and left positions, respectively.

A spacer insertion hole 21 for double retaining of the male terminals 35 is formed in the upper wall 20d of the housing body 20. When a spacer 41 (see FIG. 4) is inserted into the spacer insertion hole 21, the male terminals 35 are positioned, and are prevented from jolting, and therefore can be smoothly connected to mating female terminals (not shown), respectively.

As shown in FIG. 4, the terminal receiving chambers 31 extend through the housing body 20 in the forward-rearward direction, and the male terminals 35 are inserted through the rear wall 20c, and electrical contact portions 36 of the male terminals 35 project beyond the front wall 20b. The electrical contact portion 36 has a thin, elongate shape, and therefore is liable to be bent, and besides the electrical contact portion, when retained by a retaining piece portion 40 (described later) and the spacer 41, can be inclined. The present invention aims at solving these problems by providing the holder 50 on the connector housing 15, and the invention provides the holder-attached connector 10 in which the deformation of each electrical contact portion 36 is prevented, and the inclination of each electrical contact portion can be corrected, thereby enhancing the reliability of electrical connection of the electrical contact portion to the corresponding female terminal.

As shown in FIG. 4, the male terminal 35 has the above-mentioned electrical contact portion 36 formed at one end thereof, and has a wire connection portion 37 formed at the other end thereof. When the electrical contact portion 36 is inserted into an electrical contact portion of the female terminal, the male and female terminals are electrically connected together. The wire connection portion 37 has a pair of press-clamping piece portions 37a juxtaposed to each other in the forward-rearward direction, and the wire connection portion 37 can be press-fastened to a wire 75 (see FIG. 1) by press-deforming the press-clamping piece portions 37a. The wire connection portion 37 can be formed by press-contacting piece portions, in which case there is achieved an advantage that the wire connecting operation can be effected easily.

A primary retaining portion 38 for the elastic retaining piece portion (retaining lance) 40 and a secondary retaining piece portion 39 for the spacer 41 are formed on that portion of the male terminal disposed between the electrical contact portion 36 and the wire connection portion 37. Each retaining piece portion 40 is formed on and projects forwardly from the inner surface of the corresponding terminal receiving chamber 31, and can be elastically deformed upwardly and downwardly. Therefore, the male terminal 35 is smoothly inserted while elastically deforming the retaining piece portion 40 upwardly, and after the insertion of the male terminal 35, the retaining piece portion 40 is elastically restored downwardly, thereby preventing the rearward withdrawal of the male terminal 35.

The secondary retaining portion 39 is retained by the spacer 41 inserted into the housing body 20 through the upper wall 20d thereof. The spacer 41 retains the secondary retaining portion 39, thereby positioning the male terminal 35. Namely, the male terminal 35 is retained in a double manner by the retaining piece portion 40 and the spacer 41, and therefore the positioning and fixing of the male terminal can be effected positively.

As shown in FIG. 5, the male connector 70 has a generally rectangular box-shape, and comprises a connector housing 71, having terminal receiving chambers 73 formed therein, and the female terminals (not shown) received respectively in the terminal receiving chambers 73. The connector housing 71 includes opposite side walls 71a, upper and lower walls 71b and 71c and front and rear walls 71d and 71e. The lock projection 72 for the holder-attached connector 10 is formed on the upper wall 71b. The terminal receiving chambers 73 are open to the outer surfaces of the rear and front walls 71e and 71d. The plurality of the female terminals are so arranged as to correspond respectively to the male terminals 35. The wire 75 extends rearwardly from the male terminal 35.

As shown in FIGS. 1 and 6, the holder 50 includes a plate-like holder body 51, the pair of elastic arms 55 extending respectively from opposite side portions of the holder body 51, and a pair of ribs 65 disposed between the pair of elastic arms 55.

The holder body 51 has a shape corresponding to the shape of the fitting space 30 in the connector 10, and this holder body includes opposite side portions 51a, upper and lower portions 51b and 51c, a front surface 51d, and a rear surface 51e. Terminal passage holes 52 for respectively supporting the electrical contact portions 36 of the male terminals 35 are formed through the holder body 51, and extend from the front surface 51d to the rear surface 51e. With respect to the front and rear walls 51d and 51e, that side of the connector 70 for fitting into the connector 10 is defined as the front side as described above for the connector 10.

The pair of elastic arms 55 are integrally formed at their proximal ends with the opposite side portions 51a of the holder body 51, respectively, and extend generally perpendicularly to the rear surface 51e in the direction of insertion of the holder 50. If the elastic arms 55 extend in the direction opposite to the inserting direction, there is encountered a disadvantage that the male connector 70, when fitted into the fitting space 30, interferes with the elastic arms 55 to gouge the same.

Each of the elastic arms 55 has a generally rectangular frame-shape, and includes a pair of upper and lower beam portions 55a and 55b, and an end portion 55c interconnecting the pair of upper and lower beam portions 55a and 55b. The elastic arm 55 is thus formed into a generally rectangular frame-shape so that the pair of upper and lower beams portions 55a and 55b can be elastically deformed toward each other so as to be easily inserted into the arm insertion portion 22.

A retaining pawl (provisionally-retaining portion) 60, which can be retained by the engagement pawl 25 of the arm insertion portion 22, and a retaining projection (completely-retaining portion) 61, which can be retained by the engagement projection 26 of the arm insertion portion 22, are formed on the elastic arm 55. One of the two elastic arms 55 has the retaining pawl 60 formed on the upper beam portion 55a, and has the retaining projection 61 formed on the lower beam portion 55b, whereas the other elastic arm 55 has the retaining pawl 60 formed on the lower beam portion 55b, and has the retaining projection 61 formed on the upper beam portion 55a.

Thus, the retaining pawl 60 and the retaining projection 61, formed respectively on the upper and lower beam portions 55a, 55b, as well as the retaining projections 61, formed respectively on the two elastic arms 55, are directed reversely to each other so that reaction forces, acting respectively on the two elastic arms 55, can be directed reversely to each other, thereby firmly retaining the holder 50.

The retaining pawl 60 and the engagement projection 25 jointly form the first retaining device whereas the retaining projection 61 and the engagement projection 26 jointly form the second retaining device. The holder 50 can be retained in the provisionally-retained position by the two retaining device. The first retaining device serves to prevent the forward withdrawal of the holder 50, and the second retaining device serves to prevent the holder from easily moving from the provisionally-retained position to the deeper, completely-retained position.

The two retaining device will be described in detail with reference to FIG. 3. The retaining pawl 60 has a slanting surface 60a, formed at one side thereof, and a vertical retaining surface 60b formed at the other side thereof. Similarly, the engagement pawl 25 of the arm insertion portion 22 for engagement with this retaining pawl 60 has a slanting surface 25b at one side thereof, and a vertical retaining surface 25a formed at the other side thereof. With this construction, when the elastic arm 55 is inserted into the arm insertion portion 22, the slanting surface 60a of the retaining pawl 60 slides on the slanting surface 25b of the engagement pawl 25, and therefore the elastic arm 55 can be further inserted deeper, and when the retaining pawl 60 slides past the engagement pawl 25, the provisionally-retained condition is achieved, and in this condition the vertical retaining surfaces 25a and 60b are abutted against each other, thereby preventing the forward withdrawal of the holder 50.

The retaining projection 61 has sliding slanting surfaces 61a and 6lb formed respectively at front and rear sides thereof. Similarly, the engagement projection 26 of the arm insertion portion 22 for engagement with the retaining projection 61 has sliding slanting surfaces 26a and 26b formed respectively at front and rear sides thereof. With this construction, when the elastic arm 55 is inserted into the arm insertion portion 22, the sliding slanting surface 61a of the retaining projection 61 is brought into contact with the sliding slanting surface 26b of the engagement projection 26, so that the advance of the holder is stopped, and the provisionally-retained condition of the holder 50 is maintained, and thus the advance of the holder toward the deep side is once stopped.

Then, when the male connector 70 is fitted into the fitting space 30 to impart a pushing force of a predetermined level to the holder 50, each retaining projection 61 slides along the sliding slanting surface 26b of the engagement projection 26, so that the holder advances deeper. Then, the retaining projection 61 completely slides past the engagement projection 26, and the holder 50 is brought into the completely-retained condition, so that the fitting of the two connectors 10 and 70 relative to each other is completed.

For withdrawing the male connector 70, the sliding slanting surface 61b of each retaining projection 61 is brought into abutting engagement with the sliding slanting surface 26a of the engagement projection 26, so that the sliding movement of the holder 50 toward the provisionally-retained position is once stopped. The holder 50 can be returned from the completely-retained position to the provisionally-retained position by inserting a jig or the like into each arm insertion portion 22 from the rear side thereof and then by pushing the distal end of the elastic arm 55 back by this jig.

As described above, each retaining pawl 60 and the corresponding retaining projection 61 are offset with respect to each other in the forward-rearward direction, and with this arrangement the holder 50, disposed in the provisionally-retained position, will not be displaced out of position, and the electrical contact portions 36 of the male terminals 35, supported by the holder 50, are prevented from being broken or bent, and besides the positioning of each male terminal 35 can be effected accurately.

As shown in FIG. 6, each of the pair of ribs 65 includes a guide rib 67 and a reinforcing rib 66 which are formed integrally with each other, and the rib 65 has an L-shaped or an inverted L-shaped cross-section. The ribs 65 project in the same direction as that of projecting of the elastic arms 55, and extend substantially parallel to the elastic arms 55. The length of projecting of the rib 65 is smaller than that of the elastic arm 55. Therefore, when inserting the holder 50 into the connector housing 15, the elastic arms 55 are first inserted respectively into the arm insertion portions 22, and subsequently the ribs 65 are inserted respectively into rib receiving portions 27 formed in the front wall 20b of the housing body 20, and by doing so, the holder is positioned in the direction of the height and in the direction of the width.

As shown in FIGS. 6, 8 and 9, the reinforcing rib 66 is disposed substantially perpendicular to the guide rib 67, and the reinforcing ribs 66 are provided for the purpose of preventing the holder body 51 from being inclined forwardly and rearwardly. The reinforcing ribs 66 serve to reinforce the pair of elastic arms 55 and also to position the holder 50 in the direction of the height. With this construction, the holder body 51 is prevented from being inclined when the pushing force is applied from the male connector 70 to the holder upon insertion of the male connector 70, and by doing so, the reliability of the retaining device is maintained.

The guide ribs 67 are provided for the purpose of preventing the jolting of the holder 50 in the direction of the width at the time of insertion of the holder 50, and therefore the holder 50 advances along guide grooves 17 in the fitting hood 16, and is positioned in the direction of the width.

The elastic arms 55 extend toward the inner end of the fitting space 30, and therefore there is a fear that when the holder 50 is inserted into the fitting space, the elastic arms 55 impinge on the inner end (the front wall 20b of the housing body 20) of the fitting space 30, and fail to be inserted into the respective arm insertion portions 22. In the present invention, however, the elastic arms 55 are molded such that the two elastic arms are opened slightly outwardly away from each other, and therefore the elastic arms 55 slide in contact with the inner surface of the fitting space 30, and are positively inserted respectively into the arm insertion portions 22.

FIGS. 10 and 11 show a second embodiment of the present invention. This embodiment differs from the first embodiment in that an elastic arm 55 is provided at an upper portion 51b of a holder body 51 (while in the first embodiment, the elastic arms 55 are provided respectively at the opposite sides 51a of the holder body 51), that an arm insertion portion 22 is formed in a widthwise central portion of a wall portion 19 interconnecting opposite side walls 20a of a connector housing 15 disposed adjacent to a fitting space 30, and that ribs 65 are provided respectively at the opposite sides 51a of the holder body 51. These differences in the construction will be described below while avoiding repeating the description of the first embodiment as much as possible.

As shown in FIG. 10, the elastic arm 55 includes a pair of beam portions 55a and 55b which are juxtaposed to each other in a right-left direction. If the beam portions 55a and 55b are juxtaposed to each other in an upward-downward direction, the dimension of the connector housing 15 in the upward-downward direction increases, and the connector housing 15 can not be formed into a compact size. The pair of beam portions 55a and 55b are interconnected by an end portion 55c, and the elastic arm has a generally rectangular frame-shape as a whole so that the pair of beams portions 55a and 55b can be elastically deformed toward each other.

A retaining pawl 60 is formed on one beam portion 55a while a retaining projection 61 is formed on the other beam portion 55b. The retaining pawl 60 on the beam portion 55a and the retaining projection 61 on the beam portion 55b project in opposite directions, respectively. The retaining pawl 60 and the retaining projection 61 are offset with respect to each other in the forward-rearward direction. With this offset arrangement, the provisional retaining of the holder body 51, as well as the complete retaining thereof, can be effected.

As shown in FIG. 11, the arm insertion portion 22 is formed at such a region as to be in agreement with the elastic arm 55, and this arm insertion portion 22 has an inner peripheral surface 22a serving also as a pair of opposed guide surfaces 22b. An engagement pawl 25 (not shown in this embodiment) and an engagement projection 26 (not shown in this embodiment), which correspond respectively to the retaining pawl 60 and retaining projection 61 of the elastic arm 55, are formed on the inner surface 22a.

As shown in FIGS. 10 and 11, each of the ribs 65 has a flat plate-shape, and are disposed parallel to the elastic arm 55. The ribs 65 are connected at their proximal ends to the opposite sides 51a of the holder body 51, respectively, and free end portions thereof extend in the inserting direction of the holder body 51. The pair of ribs 65 are formed at the opposite (right and left) sides of the holder body, respectively, and each rib 65 is disposed at a central portion of the corresponding side of the holder body in the upward-downward direction, and therefore the holder body 51 can be inserted in a well-balanced manner in the upward-downward direction and right-left direction. The ribs 65 advance along guide grooves 17, respectively, and are inserted respectively into rib receiving portions 27 (not shown in this embodiment) of the connector housing, and are held in sliding contact therewith, and are restrained in the upward-downward direction and the right-left direction.

With respect to an effect achieved with the above construction, the dimension of the connector housing 15 in the direction of the width is prevented from increasing, and there is achieved an advantage that the connector housing 15 can be formed into a compact design.

In the invention, the holder is held in the provisionally-retained position when the provisionally-retaining portion and completely-retaining portion of the elastic arm are retained by the arm insertion portion. At this time, the elastic arm is embraced by the inner surface of the arm insertion portion on the four sides, and therefore the retained condition is prevented from being canceled. Therefore, the retaining is effected positively, and the holder will not move forward and rearward, and therefore the electrical contact portions of the male terminals are supported by the holder, and are prevented from interfering with an external object, and hence are prevented from being broken or bent, and besides the positioning of the male terminals can be effected accurately.

In the invention, the elastic arm is inserted into the arm insertion portion while slidingly held between (and hence guided by) the pair of opposed guide surfaces of the arm insertion portion, so that the inward (lateral) inclining of the elastic arm is prevented. Therefore, the certainty of the retaining is enhanced, thereby heightening the effect of the invention.

In the invention, the retaining pawl is retainingly engaged with the engagement pawl, thereby preventing the holder from being withdrawn forwardly from the opening of the connector housing, and the retaining projection is disposed at the inner side of the engagement projection, and therefore the sliding movement of the holder toward the completely-retained position is once stopped, thereby preventing the holder from moving forward and rearward out of the provisionally-retained position. Therefore, the holder is effectively prevented from moving forward and rearward out of the provisionally-retained position.

In the invention, the upper and lower beam portions can be elastically deformed toward each other, and therefore the elastic arm can be smoothly inserted into the arm insertion portion, so that the retaining of the holder is effected. Therefore, the insertion of the elastic arm will not be hindered, and the retaining of the holder can be effected positively, and therefore in addition to the above effects, the holder-attaching ability can be enhanced.

In the invention, the arm insertion portions are provided respectively at the opposite side portions of the connector housing, and therefore the elastic arms are inserted respectively into the arm insertion portions, so that the retaining of the holder can be effected in a well-balanced manner in the right-left direction, and the holder can support the male terminals positively.

In the invention, the arm insertion portion is provided at the central portion of the wall portion, and therefore the dimension of the connector housing in the direction of the width thereof is prevented from increasing, and thus the connector housing can be formed into a compact size.

In the invention, reaction forces, acting respectively on the elastic arms, provided respectively at the opposite (right and left) sides of the holder, are directed reversely to each other, so that the holder can be retained firmly. Therefore, the holder is prevented from moving forward and rearward within the fitting space in the connector housing.

In the invention, the retaining pawl and the engagement pawl have the respective vertical abutting surfaces which can abut against each other, and therefore the holder, disposed in the provisionally-retained position, is positively prevented from being withdrawn forwardly from the opening. The retaining projection and the engagement projection have the slanting surfaces which can abut against each other, and therefore the holder can be slid in the opposite directions between the completely-retained position and the provisionally-retained position. Therefore, the certainty of the retaining is enhanced, and besides the male terminals can be effectively protected.

In the invention, the holder is held in the provisionally-retained position by the double retaining device, and the electrical contact portions are supported at their generally middle portions by the holder. Therefore, the electrical contact portions of the male terminals are prevented from being broken or bent, thereby enhancing the reliability of the electrical connection.

In the invention, the holder is accurately positioned in the direction of the width thereof, and therefore will not jolt, and can accurately guide and support the electrical contact portions of the male terminals, and therefore the electrical contact portions can be effectively protected.

In the invention, the reinforcing rib prevents the holder from being inclined forwardly and rearwardly, and enables the holder to be accurately positioned in the direction of the height. Therefore, the deformation of the elastic arm is avoided, and the reliability of the retained condition is not lowered, and the holder can be held in the provisionally-retained condition, and the holder can be inserted into the fitting space in the connector housing without jolting.

What is claimed is:

1. A holder-attached connector comprising:
a connector housing including a fitting hood having a fitting space;
male terminals inserted respectively in terminal receiving chambers communicating with said fitting space;
a holder which has terminal passage holes for said male terminals, and is slidingly inserted in said fitting space;
an elastic arm formed on said holder, said elastic arm extending in a direction of insertion of said holder;
a provisionally-retaining portion and a completely-retaining portion for engagement with said connector housing provided at said elastic arm; and
an arm insertion portion for embracing said elastic arm provided on said connector housing.

2. A holder-attached connector according to claim 1, wherein said arm insertion portion has a pair of opposed guide surfaces for sliding contact respectively with opposite side faces of said elastic arm spaced from each other in a direction of a plate thickness of said elastic arm.

3. A holder-attached connector according to claim 1, wherein said provisionally-retaining portion is a retaining pawl, and said completely-retaining portion is a retaining projection, and an engagement pawl for said retaining pawl and an engagement projection for said retaining projection are provided at said arm insertion portion.

4. A holder-attached connector according to claim 1, wherein said elastic arm includes a pair of beam portions, extending in the direction of insertion of said holder, and an end portion interconnecting said pair of beam portions, and said provisionally-retaining portion is provided at one of said pair of beam portions while said completely-retaining portion is provided at the other beam portion.

5. A holder-attached connector according to claim 1, wherein said arm insertion portions are provided respectively at opposite side walls of said connector housing disposed adjacent to said fitting space.

6. A holder-attached connector according to claim 1, wherein said arm insertion portion is provided at a central portion of a wall portion of said connector housing interconnecting opposite side walls of said connector housing.

7. A holder-attached connector according to claim 5, wherein said retaining pawl formed on one of said elastic arms for insertion into the corresponding arm insertion portion, and said retaining pawl formed on the other elastic arm for insertion into the other arm insertion portion, are directed reversely to each other.

8. A holder-attached connector according to claim 3, wherein each of said retaining pawl and said engagement pawl has a vertical retaining surface disposed perpendicular to the direction of insertion of said holder, and each of said retaining projection and said engagement projection has slidable, sliding slanting surfaces formed respectively at front and rear sides thereof.

9. A holder-attached connector according to claim 3, wherein said retaining pawl and said engagement pawl jointly form a first retaining device, and said retaining projection and said engagement projection jointly form a second retaining device, and said holder is held in a provisionally-retained position by said first retaining device and said second retaining device.

10. A holder-attached connector according to claim 1, wherein a guide rib for being guided by a guide groove, formed in said fitting hood, is formed on said holder.

11. A holder-attached connector according to claim 1, wherein a reinforcing rib for insertion into a rib receiving portion, formed in a front wall of a housing body disposed adjacent to said fitting hood, is formed on said holder.
